(19) United States
(12) Patent Application Publication
(10) Pub. No.: US 2005/0289099 A1
(43) Pub. Date: Dec. 29, 2005

(54) System and method for searching software repositories

(75) Inventor: Tatjana Gromyko, Edigen-Neckarhausen (DE)

Correspondence Address: KENYON & KENYON, 1500 K STREET NW, SUITE 700, WASHINGTON, DC, 20005, US

(73) Assignee: SAP Aktiengesellschaft

(21) Appl. No.: 10/876,567

(22) Filed: Jun. 28, 2004

(51) Int. Cl. G06F 7/00

(52) U.S. Cl. 707/1

(57) ABSTRACT

A system and method for searching a software database to locate summaries of software modules, methods and classes that pertain to keywords extracted from a formulation of a software problem. The software problem formulation is parsed to extract keywords pertaining to the subject matter of the problem. The extracted keywords are then arranged into a query, which is submitted to a software module database. Software module summaries obtained from software module databases in response to the query are sorted and formatted for display to a user, who may then study the displayed summaries to determine which software modules to investigate further in order to develop a possible solution to the reported software problem.

### TECHNICAL FIELD

This invention relates generally to techniques for facilitating software development for applications having large numbers of software modules. More particularly, the invention relates to software source module searching techniques. Still more particularly, the invention relates to methods and systems for improving the efficiency and functionality of automated processes that assist software database searching activities based on keywords derived from software problem formulations.

### BACKGROUND OF THE INVENTION

The process of developing, maintaining, repairing and enhancing software can be an extremely daunting task, particularly in the context of large systems that contain hundreds or thousands of software modules. Even after completed software modules have undergone long hours of extensive testing, errors may still remain and design shortcomings may still be discovered as new software requirements are discovered during normal use. To respond to customer reports of discovered errors and design oversights, many software manufacturers establish dedicated customer service facilities. These facilities, sometimes referred to as “help desks” or “call centers,” receive, catalog and respond to customer reports of errors discovered or perceived to exist in delivered software products.

Help desks are labor intensive efforts. Knowledgeable support analysts typically review error reports as they arrive, in order to understand the subject matter and the content of the report. Based on that review, a support analyst may then search various databases containing solutions that were developed to solve previously reported errors. If an appropriate solution is found in one of the databases, the support analyst may send that solution to the customer who reported the error. Otherwise, the analyst will usually forward the error report to an appropriate engineering group for further study.

According to empirical evidence, between 60 and 90 percent of errors reported by customers have already been solved. For these solved errors, no new engineering is required. Instead, a support analyst need only locate the appropriate solution and send it to the customer. However, the remaining 10 to 40 percent of customer error reports must be investigated and solved by engineers.

When a software engineer is assigned the task of fixing a reported error, the engineer may first attempt to determine which particular software modules require modification. This may be a difficult undertaking. Indeed, for a number of reasons, including the engineer's level of experience, the scope of the problem, the extent of existing documentation, and the clarity of the software code itself, a software engineer may require significant amounts of time to determine where to begin. The relevant software modules requiring modification may not be known to the engineer and may not be immediately obvious from a cursory examination. Currently, software engineers manually browse software repositories to discover software modules, objects and methods that are believed to be most relevant to a reported error. Efforts to reduce the search time required to identify these relevant software modules will significantly reduce the overall costs required to develop solutions to reported errors.

Similarly, when an engineer begins the task of designing a new software functionality, the engineer may also attempt to search existing software repositories in order to determine which particular software modules may provide the best foundation from which the new software functionality may be achieved. Software engineers currently browse software repositories manually in order to discover the software modules, objects and methods that are believed to be most relevant. Efforts to reduce the search time required to identify these relevant software modules will significantly reduce the overall costs required to develop new functionality as well as to improve existing software capabilities.

Accordingly, there is a need in the art for a system and method for using reported error descriptions as a basis for extracting keywords that may be used to search software documentation repositories to locate information likely to be relevant to a possible solution to the software problem. Likewise, there is a need in the art for a system and method for using software capability formulations as a basis for extracting keywords that may be used to search software repositories to locate software modules most apt to be relevant to the design of a new software capability or functionality.

### SUMMARY OF THE INVENTION

Embodiments of the present invention are directed to a system and method for searching a software database to locate summaries of software modules, methods and classes that pertain to keywords extracted from a formulation of a software problem. The software problem formulation is parsed to extract keywords pertaining to the subject matter of the problem. The extracted keywords are then arranged into a query, which is submitted to a software module database. Software module summaries obtained from software module databases in response to the query are sorted and formatted for display to a user, who may then study the displayed summaries to determine which software modules to investigate further in order to develop a possible solution to the reported software problem.

### BRIEF DESCRIPTION OF THE DRAWINGS

FIG. 1 is a high-level block diagram of a computer system incorporating a method and system for searching a software database to locate summaries of software modules in accordance with an embodiment of the present invention.

FIG. 2 is a flow chart illustrating one method for searching a software repository to determine which software documents are most relevant to a possible solution to a reported software error, according to an embodiment of the present invention.

FIG. 3 is a flow chart illustrating one method for searching a software repository to determine which software modules are most relevant to address a proposed software formulation, according to an embodiment of the present invention.

FIG. 4 is a simplified block diagram of a computer system useful with the present invention.

### DETAILED DESCRIPTION

Embodiments of the present invention will be described with reference to the accompanying drawings, wherein like parts are designated by like reference numerals throughout, and wherein the leftmost digit of each reference number refers to the drawing number of the figure in which the referenced part first appears.

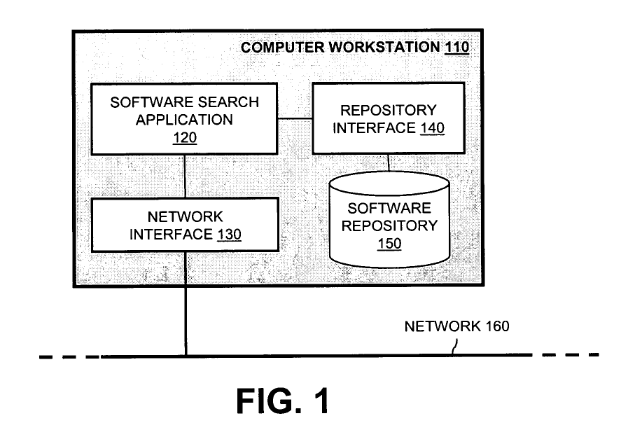

FIG. 1 is a high-level block diagram of a computer system incorporating a method and system for searching a software database to locate summaries of software modules in accordance with an embodiment of the present invention. As shown in FIG. 1, computer workstation 110 may be a computer having a processor and a memory configured to enable a software engineer to receive software problem formulations. To assist the software engineer, computer workstation 110 may include software search application 120, which receives the software problem formulations, searches for potential software modules that match keywords extracted from the problem formulations, and displays the potential list of relevant software modules on computer workstation 110 for review by the software engineer. According to an embodiment, software search application 120 communicates with network interface 130 to receive software problem formulations from other computers via network 160. Alternatively, software search application 120 may receive a software problem formulation directly via means such as keyboard input.

Continuing to refer to FIG. 1, network interface 130 may include specific software methods and objects that enforce a desired error reporting protocol. Additionally, software search application 120 may interact with software repository 150 via repository interface 140. Software repository 150 may correspond to a database of software modules, objects and methods. Software repository 150 may also contain summary documentation associated with the software modules, objects and methods, in addition to other notes, white papers, design requirements and information pertaining to software development activities. Repository interface 140 may comprise a traditional database management system interface using, for example SQL as a means of interacting with software repository 150. Alternatively, repository interface 140 may comprise a library of customized interface modules capable of interacting with software repository 150 using source code control methods known in the art.

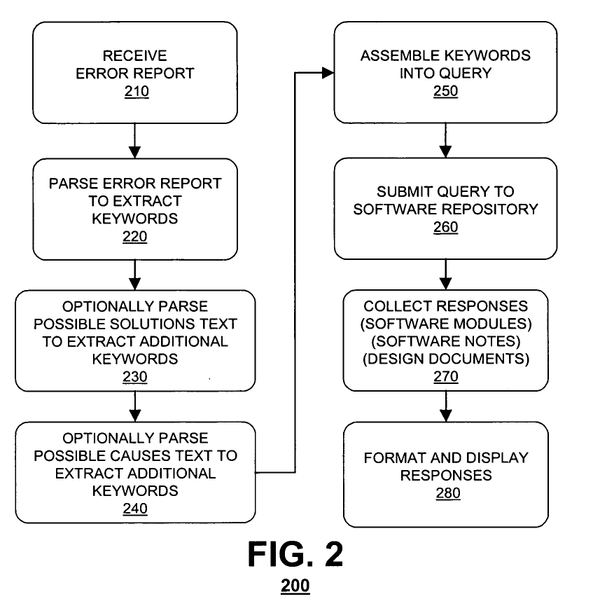

FIG. 2 is a flow chart illustrating one method for searching a software repository to determine which software documents are most relevant to a possible solution to a reported software error, according to an embodiment of the present invention. Method 200 initially receives a software error report (210). Software error reports may be initiated by customers, or may be generated by help desks that compile information about software errors. Software error reports may also be produced by software engineers who have an understanding of certain design deficiencies. Software error reports may comprise text messages describing a particular problem. On the other hand, software error reports may also comprise structured messages containing a variety of well-defined fields. For example, according to an embodiment, a software error report may contain a problem description field, a possible cause field, and a possible solution field, each of which may include textual information relating to the problem at hand.

Continuing to refer to FIG. 2, when a software error report has been received (210), an embodiment of the present invention may then parse the error report to extract important keywords identifying the subject matter of the problem (220). To extract significant keywords that will enable a search engine to return the most appropriate software documents, method 200 may optionally parse keywords from the various specific fields of the software error report, including text describing possible solutions to the problem (230) or possible causes of the problem (240). Alternatively, method 200 may parse keywords from a general text field. Method 200 may also filter the parsed keywords to identify those most keywords likely to result in a match with known software capabilities.

Once the appropriate keywords have been extracted and filtered, the keywords may be assembled to formulate and submit a query that will search one or more repositories of software-related documents (250). After the query has been submitted (260), records matching the keywords may be returned from the software repositories. These received responses may be collected (270) and then formatted and displayed for review and analysis by a software engineer (280).

Matching records returned from software repositories may comprise information gathered from software modules. Matching records returned from the software repositories may also comprise design information and other notes and papers relating to the development, performance and maintenance of the software.

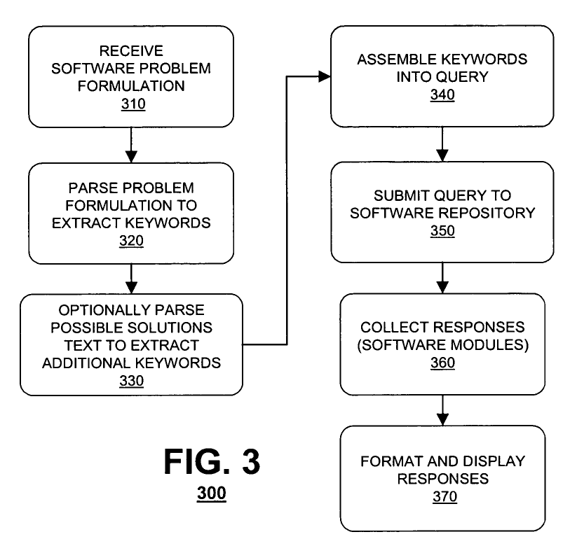

FIG. 3 is a flow chart illustrating one method for searching a software repository to determine which software modules are most relevant to address a proposed software formulation, according to an embodiment of the present invention. Method 300 initially receives a software problem formulation (310). Software problem formulations may be initiated by customers, or may be produced by software engineers who have an understanding of certain design features or parameters. Software problem formulations may comprise text messages describing a particular problem or desired capability. On the other hand, software problem formulations may also comprise structured messages containing a variety of well-defined fields. For example, according to an embodiment, a software problem formulation may contain a problem description field and a possible solution field, each of which may include textual information relating to the problem at hand.

Continuing to refer to FIG. 3, when a software problem formulation has been received (310), an embodiment of the present invention may then parse the problem formulation to extract important keywords identifying the subject matter of the problem (320). To extract significant keywords that will enable a search engine to return the most appropriate software modules, method 300 may optionally parse keywords from the various specific fields of the software problem formulation, including text describing possible solutions to the problem (330). Alternatively, method 300 may parse keywords from a general text field. Method 300 may also filter the parsed keywords to identify those most likely to result in a match with known software modules.

Once the appropriate keywords have been extracted and filtered, the keywords may be assembled to formulate and submit a query that will search one or more repositories of software modules (340). After the query has been submitted (350), records matching the keywords may be returned from the software repositories. These received responses may be collected (360) and then formatted and displayed for review and analysis by a software engineer (370).

A software repository or database may be constructed according to a variety of methods known in the art. For example, software modules may be stored in a database as records containing free-form text. Alternatively, software modules may be stored in a more structured manner, according to various fields that may correspond to the different categories of information, as well as different software component attributes. An embodiment of the present invention may use the extracted keywords to search one or more tables in a solutions database.

When responses are formatted and displayed for review and analysis by a software engineer, an embodiment of the present invention may sort the responses according to an identified sort preference. The sort preference may be set to a default value, may be set by the software engineer, or may be responsive to the types of responses received and/or the responses being displayed. For example, one sort preference may sort responses according to the number of different search keywords found in each responses returned from the software repositories. Another sort preference may sort solutions according to the number of times the search keywords appear in each returned response. Yet another sort preference may sort solutions according a popularity value; that is, the number of times each returned software module has been returned as a possible response to other previously entered software problem formulation.

When sorted software modules are displayed for review and analysis, an embodiment may partition the displayed information according to the structure of the database tables from which the information was retrieved (see item 280 of FIG. 2 and item 370 of FIG. 3). Thus, a display of potential software modules and/or documentation may comprise many rows, where each row includes several different columns corresponding to different categories of information. One category may correspond to design notes derived from a notes table in the software repository. Another displayed category may include the software components relevant to each solution. Yet another category may include software component release information or solution popularity and sort statistics.

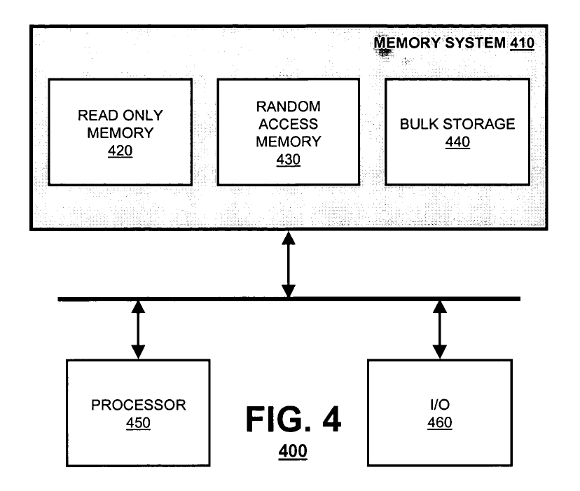

Functionality of the foregoing embodiments may be provided on various computer platforms executing program instructions. One such platform 400 is illustrated in the simplified block diagram of FIG. 4. There, the platform 400 is shown as being populated by a processor 450, a memory system 410 and an input/output (I/O) unit 460. The processor 450 may be any of a plurality of conventional processing systems, including microprocessors, digital signal processors and field programmable logic arrays. In some applications, it may be advantageous to provide multiple processors (not shown) in the platform 400. The processor(s) 450 execute program instructions stored in the memory system 410. The memory system 410 may include any combination of conventional memory circuits, including electrical, magnetic or optical memory systems. As shown in FIG. 4, the memory system may include read only memories 420, random access memories 430 and bulk storage 440. The memory system not only stores the program instructions representing the various methods described herein but also may store the data items on which these methods operate. The I/O unit 460 would permit communication with external devices (not shown).

Several embodiments of the present invention are specifically illustrated and described herein. However, it will be appreciated that modifications and variations of the present invention are covered by the above teachings and within the purview of the appended claims without departing from the spirit and intended scope of the invention.

1. A method for searching a software repository, comprising:
parsing a formulation of a software capability;
extracting a plurality of keywords from the formulation, said keywords pertaining to the subject matter of the software capability;
assembling a query using the keywords as selection criteria;
submitting the query to a software repository;
collecting software information returned from the software module database in response to the submitted query;
sorting the collected software information based on a sort preference; and
formatting the sorted software information for display.

2. The method of claim 1, wherein the collected software information includes a plurality of software module summaries.

3. The method of claim 1, wherein the collected software information includes a plurality of software design notes.

4. The method of claim 1, wherein the formulation contains a plurality of text fields that are parsed to extract the plurality of keywords.

5. The method of claim 4, wherein at least one of the text fields comprises possible design solutions to achieve the software capability.

6. A machine-readable medium having stored thereon a plurality of instructions for searching a software database, the plurality of instructions comprising instructions to:
parse a formulation of a software problem;
extract a plurality of keywords from the formulation, said keywords pertaining to the subject matter of the software problem;
assemble a query using the keywords as selection criteria;
submit the query to a software database;
collect software module summaries returned from the software database in response to the submitted query;
sort the collected software module summaries based on a sort preference; and
format the sorted software module summaries for display.

7. The machine-readable medium of claim 6, wherein the formulation contains a plurality of text fields and the plurality of instructions comprise instructions to parse the text fields to extract the plurality of keywords.

8. The machine-readable medium of claim 7, wherein the plurality of text fields comprise possible causes of the software problem.

9. The machine-readable medium of claim 7, wherein the plurality of text fields comprise possible solutions to the software problem.

10. The machine-readable medium of claim 6, wherein the sort preference corresponds to the number of keywords found in each solution record.

11. A computer system, including:
a processor coupled to a network;
a software solutions storage repository coupled to the processor;
a memory coupled to the processor the memory containing a plurality of instructions to implement a method for searching a software solutions database, the method comprising:
parsing a textual description of a software problem;
extracting a plurality of keywords from the description, said keywords reflective of the software problem or possible solutions to the software problem;
assembling a query using the keywords as selection criteria;
submitting the query to a software solutions storage repository;
collecting solution records returned from the software solutions storage repository in response to the submitted query;
sorting the collected solution records based on a sort preference; and
formatting the sorted solution records for display.

12. A method for searching a software repository, comprising:
parsing a software error description;
extracting a plurality of keywords from the software error description, said keywords pertaining to the subject matter of the software error;
assembling a query using the keywords as selection criteria;
submitting the query to a software repository;
collecting software module summaries returned from the software module database in response to the submitted query;
sorting the collected software module summaries based on a sort preference; and
formatting the sorted software module summaries for display.

13. The method of claim 12, wherein the collected software module summaries includes a plurality of software design notes.

14. The method of claim 12, wherein the software error description contains a plurality of text fields that are parsed to extract the plurality of keywords.

15. The method of claim 14, wherein at least one of the text fields comprises possible causes of the software error.

16. The method of claim 14, wherein at least one of the text fields comprises possible solutions to the software error.
